(19) United States
(12) Patent Application Publication
(10) Pub. No.: US 2008/0234944 A1
(43) Pub. Date: Sep. 25, 2008

(54) Method and Apparatus for Subset Selection with Preference Maximization

(75) Inventors: J. David Schaffer, Wappingers Falls, NY (US); Angel Janevski, New York, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,977

(22) PCT Filed: Jul. 11, 2006
(86) PCT No.: PCT/IB2006/052344

§ 371 Date: Jan. 17, 2008

Related U.S. Application Data
(60) Provisional application No. 60/701,339, filed on Jul. 21, 2005.

(51) Int. Cl. G06F 19/00

(52) U.S. Cl. 702/19

(57) ABSTRACT

A method and apparatus for determining a subset of measurements from a plurality of measurements in a genetic algorithm is disclosed. The method comprising the steps of determining a fitness measure for each sub-set of the measurements, wherein each measurement has an associated fitness measure and selecting the subset of measurements having the lowest fitness measure (110, 120). The method further comprises the steps of determining a cost function for each subset of measurements, wherein each measurement includes an associated cost and selecting the subset of measurements having the lowest cost function (150, 170).

This application relates to the field of search processes in genomics-based testing and, more specifically, to an improved method to include more measurements in the search process.

Subset selection problems are known to occur in a number of domains; for example, a pattern discovery for molecular diagnostics. In this domain, measurement data are typically available on patients with or without a specific disease, and there is a desire to discover a subset of these measurements that can be used to reliably detect the disease. Evolutionary computation is one known method that can be used for determining a subset of measurements from the available measurements. Examples of evolutionary computations may be found in filed patent applications WO0199043, and WO0206829 and in Philips Tr-2-3-12, Petricoin et. al., The Lancet, Vol. 359, 16 Feb. 2002, pp. 572-577.

Evolutionary search algorithms with some form of a subset selection have the property of taking into account a subset of the entire search space at a time. For example, a population of 100 chromosomes with 15 genes in each can only cover at most 1,500 distinct genes. If the search space contains more than 1,500 genes, it is not guaranteed, in general, that the algorithm will try out every gene at least once. The brute-force solution to this problem would be to increase the population size and/or the chromosome size, which is generally not practical as it adds a substantial computation burden to the algorithms.

However, while accurate and small subsets can be discovered with the methods described in the prior art, there are often additional criteria that may or need be applied. For instance, some measurements may be more or less reliable than others; some may require more costly reagents or measurement equipment than others; some measurements may involve bio-molecules whose function in the disease process is better understood than others, etc.

Hence, there is a need in the industry for a method that allows for the inclusion or testing of additional criteria to be taken into account in a search.

A method and apparatus for determining a subset of measurements from a plurality of measurements in a genetic algorithm is disclosed. The method comprises the steps of determining a fitness measure for each of a subset of the measurements, wherein each measurement has an associated fitness measure and selection as the subset of measurements having the lowest fitness measure. The method further comprises the steps of determining a cost function for each subset of measurements, wherein each measurement includes an associated cost and selecting the subset of measurements having the lowest cost function.

The invention may take form in various components and arrangements of components, and in various process operations and arrangements of process operations. The drawings are only for the purpose of illustrating preferred embodiments and are not to be construed as limiting the invention.

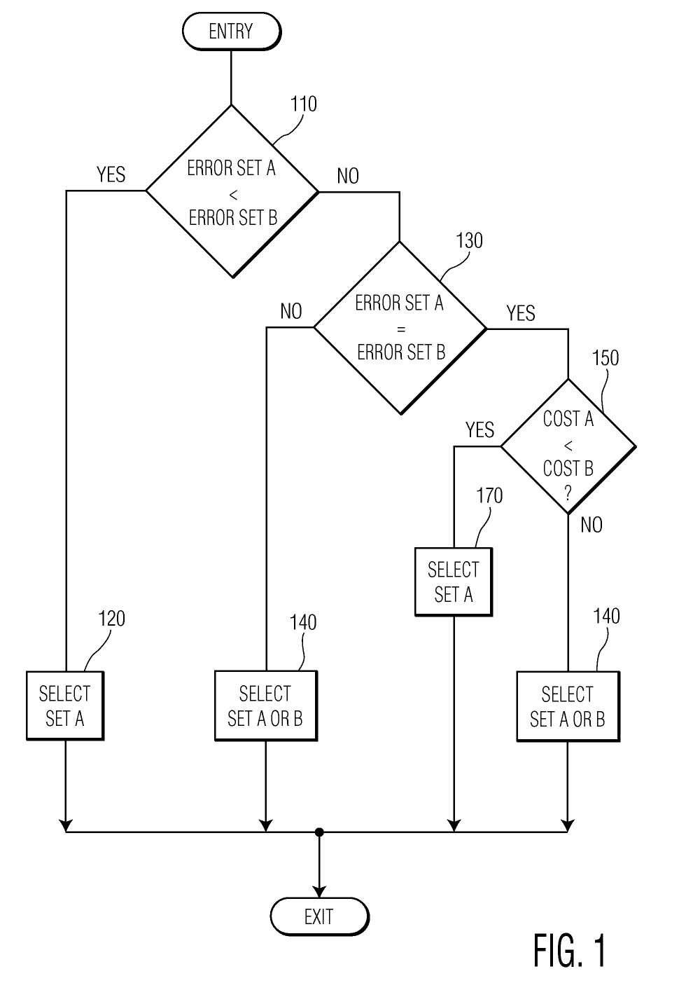

FIG. 1 illustrates an exemplary process for incorporating additional selection criteria in accordance with the principles of the invention.

It is to be understood that these drawings are for purposes of illustrating the concepts of the invention and are not drawn to scale. It will be appreciated that the same reference numerals, possibly supplemented with reference characters where appropriate, have been used throughout to identify corresponding parts.

U.S. Patent Application Ser. No. 60/639,747, entitled “Method for Generating Genomics-Based Medical Diagnostic Tests, filed on Dec. 28, 2004, the contents of which are incorporated by reference, herein, describes one method for determining a classifier by generating a first generation chromosome population of chromosomes, wherein each chromosome has a selected number of genes specifying a subset of an associated set of measurements. In this described method, the genes of the chromosomes are computationally genetically evolved to produce successive generation chromosome populations. The production of each successor generation chromosome population includes: generating offspring chromosomes from parent chromosomes of the present chromosome population by: (i) filling genes of the offspring chromosome with gene values common to both parent chromosomes and (ii) filling remaining genes with gene values that are unique to one or the other of the parent chromosomes; selectively mutating genes values of the offspring chromosomes that are unique to one or the other of the parent chromosomes without mutating gene values of the offspring chromosomes that are common to both parent chromosomes; and updating the chromosome population with offspring chromosomes based on the fitness of each chromosome determined using the subset of associated measurements specified by genes of that chromosome. A classifier is then selected that uses the subset of associated measurements specified by genes of a chromosome identified by the genetic evolution.

The method described in the referenced commonly-owned patent application, the teachings of which are incorporated by reference, employs a two-level hierarchical selection step, i.e., survival-of-the-fittest, designed to induce the evolution of accurate and small subsets. As described, competing solutions, i.e., different chromosomes, i.e., parents and offspring, referred to as A and B, herein, for the problem are compared as follows:

If (classification_errors (A)<classification_errors (B), then A is selected;

Else, if (classification_errors (A)=classification_errors (B), and
(number_of measurements(A)<number_of measurements(B), then A is selected;

Otherwise, select A or B at random,
where classification_error( ) represents a fitness measure.

To achieve a desired minimization of a preference score, a score or a cost may also be associated with each of the available measurements. A function may then be determined by considering the total cost of any subset of measurements.

This inclusion of cost may be expressed mathematically as:

If (classification_errors (A)<classification_errors (B), then A is selected;

Else If
(classification_errors (A)=classification_errors (B),
   AND
(cost_of (A)<cost_(B), then A is selected.

Otherwise, select A or B at random.

FIG. 1 illustrates a flow chart of an exemplary process 100 in accordance with the principles of the invention. In this illustrated process, a determination is made at block 110 whether the classification errors of a first set, i.e., A, are less than the classification of a second set, i.e., B. If the answer is in the affirmative, then the first set is selected at block 120.

However, if the answer at block 110 is negative, then a determination is made at block 130 whether the classification errors of a first set, i.e., A, is equal to the classification of a second set, i.e., B. If the answer is negative, then either the first set or the second set may be selected at block 140.

However if the answer at block 130 is in the affirmative, then a determination is made, at block 150, whether the cost associated with the first set is less than the cost associated with the second set. If the answer is in the affirmative, then the first set is selected at block 170. Otherwise, then either the first set or the second set may be selected at block 140. As would be recognized the selection of either the first set or the second set may be selected randomly using well-known random generators or may be fixed to always select one set or the other.

The cost function can be implemented in a variety of ways that reflect a particular preference or penalty for the inclusion of a subset of genes. A simple static cost function could use values assigned to each gene (e.g., 0=preferred, 1=not-preferred), where the output of the function is a sum of the preference values. This concept is easily generalized to cost functions that include a broader range of values than {0,1}. Therefore, a chromosome with all genes preferred would outperform a chromosome containing one or more genes that are tagged to be avoided. The concept may be further generalized to include a hierarchy of cost criteria that is descended only when there is a tie at the previous level. For example, cost criterion 1 might be the “preferred” genes (refer to the example above), and cost criterion 2 (consulted only if two chromosomes are tied on criterion 1) might be a reagents-cost criterion. In another implementation, the cost function could utilize tags that are dynamically updated during the course of an experiment. For example, the preference for a gene could be updated to “not-preferred” in case the gene is present in a given portion of the population. For example, a gene will remain tagged as preferred as long as the gene is present in 30% or fewer chromosomes in the population.

A system according to the invention can be embodied as hardware, a programmable processing or computer system that may be embedded in one or more hardware/software devices, loaded with appropriate software or executable code. The system can be realized by means of a computer program. The computer program will, when loaded into a programmable device, cause a processor in the device to execute the method according to the invention. Thus, the computer program enables a programmable device to function as the system according to the invention.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

1. A method for determining a subset of measurements from a plurality of measurements in a genetic algorithm, wherein each measurement has an associated fitness measure and cost, the method comprising the steps of:
determining a fitness measure for each subset of the measurements;
selecting the subset of measurements having a lowest fitness measure (110, 120).

2. The method as recited in claim 1, further comprising the steps of:
determining a cost function for each subset of measurements; and
selecting the subset of measurements having a lowest cost function (150, 170).

3. The method as recited in claim 1, wherein the associated cost comprises a computation based on a first and second state, wherein the first state represents a preferred value and the second state represents a non-preferred value.

4. The method as recited in claim 3, wherein the cost function represents the sum of the first and second states of each of the measurements in the subset of measurements.

5. The method as recited in claim 3, wherein the cost function represents the sum of the first states of each of the measurements in the subset of measurements.

6. An apparatus for determining a subset of measurements from a plurality of measurements in a genetic algorithm, wherein each measurement has an associated fitness measure and cost, the apparatus comprising:
a computer executing code for:
determining a fitness measure for each subset of the measurements;
selecting the subset of measurements having a lowest fitness measure (110, 120).

7. The apparatus as recited in claim 6, wherein the computer further executes a code for:
determining a cost function for each subset of measurements; and
selecting the sub-set of measurements having a lowest cost function (150, 170).

8. The apparatus as recited in claim 6, wherein the associated cost comprises a computation based on a first and second state, wherein the first state represents a preferred value and the second state represents a non-preferred value.

9. The apparatus as recited in claim 8, wherein the cost function represents the sum of the first and second states of each of the measurements in the subset of measurements.

10. The apparatus as recited in claim 8, wherein the cost function represents the sum of the first states of each of the measurements in the subset of measurements.

11. A computer software product containing a code providing instructions to a computer for determining a subset of measurements from a plurality of measurements in a genetic algorithm, wherein each measurement has an associated fitness measure and cost, the code instructing the computer to execute the steps of:
determining a fitness measure for each subset of the measurements;
selecting the subset of measurements having a lowest fitness measure (110, 120).

12. The computer program product as recited in claim 11, wherein the code further instructs the computer to execute the steps of:
determining a cost function for each subset of measurements; and
selecting the subset of measurements having a lowest cost function (150, 170).

13. The computer program product as recited in claim 11, wherein the associated cost comprises a computation based on a first and second state, wherein the first state represents a preferred value and the second state represents a non-preferred value.

14. The computer program product as recited in claim 13, wherein the cost function represents the sum of the first and second states of each of the measurements in the subset of measurements.

15. The computer program product as recited in claim 12, wherein the cost function represents the sum of the first states of each of the measurements in the subset of measurements.
